(19) United States
(12) Patent Application Publication
(10) Pub. No.: US 2016/0256347 A1
(43) Pub. Date: Sep. 8, 2016

(54) EAR MASSAGE DEVICE

(71) Applicant: Ronald Zimmermann, Telfs (AT)

(72) Inventor: Ronald Zimmermann, Telfs (AT)

(21) Appl. No.: 14/639,525

(22) Filed: Mar. 5, 2015

(51) Int. Cl. A61H 7/00

(52) U.S. Cl. CPC A61H 7/005; A61H 2205/027

(57) ABSTRACT

The invention relates to an ear massage device comprising a motor (2), a shaft (3) that can be driven by the motor (2) about a rotational axis (X) and a massage part (5). The device is characterised by an eccentric (4), which is connected to the shaft (3) and on which the massage part (5) is located, and is characterised in that the shaft (3) can be driven by the motor (2) at a maximum 100 revolutions per minute.

### CROSS REFERENCE TO RELATED APPLICATIONS

This application is a National Stage of International Application No. PCT/EP2013/002669, filed Sep. 5, 2013 which claims priority to European Patent Application No. 12006300.3, filed Sep. 6, 2012. The contents of all these applications are expressly incorporated herein by reference in their entireties.

### BACKGROUND

The present invention relates to an ear massage device with the features of the preamble of claim 1.

Numerous devices are described in the state of the art which are intended to contribute to relief or healing of tinnitus by producing various stimuli on the ear.

Besides irradiation with light of various wavelengths, the transmission of vibrations, i.e. mechanical action at high frequency, is amongst the treatment methods that are most used. Thus, for instance, in EP 1 486 186 B1 or EP 0 778 017 A2 devices are disclosed that enable the ear to be treated, inter alia, by means of vibrations applied in and around the ear.

### SUMMARY

The object of the present invention consists in improving the somewhat moderate successes in the treatment of tinnitus by mechanical action.

This object is achieved by an ear massage device with the features of claim 1.

According to the invention, this is effected by massage of the auricle, in particular around the region of the helix, antihelix, tragus and antitragus.

The manner of achieving rotation of the shaft, to which the eccentric is attached, at less than 100 revolutions per minute is not of importance for the invention. For example, this can be effected by a motor with this rotational speed, or by the additional use of a transmission.

It is important that the massage be performed slowly, in particularly not in a vibratory manner. This will induce, inter alia, at least small movements of the auricle, or of the ear, as far as into the inner ear. This results in clear successes in treatment, which are due to the presence of various acupuncture points at the relevant part of the ear. The heat produced by the friction occurring during the massage is also advantageous for the patient.

A further advantage of the invention is the attainment of a deep relaxation phase, which has numerous positive effects. These include improvement of sleep behaviour, through to the treatment of sleep disorders, relaxation of the muscle and tendon apparatus adjoining the ear, as well as positive effects upon the psyche.

For particularly good successes in treatment, it may be advantageous to provide a treatment time of two times ten minutes for each ear, with alternation of the direction of rotation of the massage. In particular, from practical experience, it appears that a period of sleep or rest following the treatment may be advantageous.

Further advantageous embodiments of the invention are defined in the dependent claims.

In order to avoid the generation of noise by any transmission, it may be provided that the motor is connected directly to the shaft.

For a simple design, it is advantageous that the massage part be designed as a single piece with the eccentric.

For the purpose of adapting to differing ears and the differing tinnitus pathologies, it may be advantageous that the eccentric be detachably connected to the shaft and/or the massage part be detachably connected to the shaft.

In order to achieve a support effect for the rest of the ear, it may be provided that a plate, extending at right angles to the rotation axis, be connected to the massage part or formed on the massage part. A padding or a shaped part may be provided on the plate, so that the contact against the ear is made more pleasant. The padding or the shaped part may preferably be made of plastic, rubber, foam or wood or the like. In particular, the shaped part need not be soft.

In order to enable circular motions of the massage part, but without causing the massage part to rotate about an axis of symmetry or the like, it may be provided that the plate and/or the massage part be mounted—in particular, movably—separately from the eccentric, on the housing of the device.

The motion of the eccentric can be transmitted particularly easily to the massage part by a guide profile on the plate or on the massage part, which guide profile acts in combination with the eccentric. In order to achieve a tolerance of movements of the massage part in the direction of the rotation axis of the shaft, it may be provided that the guide profile be realized as the inner wall of a tube.

For cost reasons, and in order to create a pleasant surface, it may be provided that the massage part and/or the plate be made of plastic or foam or the like.

For a particularly pleasant contact of the massage part against the inner part of the auricle, it may preferably be provided that the massage part is formed substantially hemispherical or spherical.

To enable the device to cater individually to differing patients, a setting device may be provided, by which the speed and/or the direction of rotation of the electric motor may be set.

In order to compensate any relative movements of the massage part and ear during the treatment, it may be provided that the shaft or the massage part be spring-mounted in the direction of the rotation axis. It is conceivable to design the device in such a way that the spring elements are exchangeable, in order to meet the requirements of differing patients. For a particularly accurate setting of the spring effect, it is conceivable to design the shaft to be telescopic, with an integrated gas pressure cylinder or the like.

It may also be provided, however, that the massage part be mounted by means of three spring devices, wherein the shaft has a joint. The presence of a joint enables the massage part to be tilted out of a plane perpendicular to the rotation axis. In comparison with a telescopic design of the shaft, in the case of a spring mounting, a more accurate response of the spring mounting can be achieved since, in comparison with the telescopic design, there are no moments acting outside of the telescope axis that would increase an increase in the friction in the telescopic shaft.

Clearly, it is possible to equip the shaft with a joint and to use only one or two spring devices. However, the mentioned technical effect of the better response of the spring mounting can be optimized by using three or more spring devices.

Since the shaft is realized, at least partially, as a tube which has two slots that are parallel to the rotation axis, and the shaft has a ball and has a pin extending through the ball, transversely in relation to the rotation axis, wherein the joint is formed by combined action of the ball with the tube, on the one hand, and of the pin with the slots, on the other hand, a joint that additionally tolerates displacements along the rotation axis of the shaft can be realized in a particularly simple manner in terms of structure.

In order to achieve a deeper relaxation phase, a cushion with an opening may be provided, wherein the massage part is disposed in or at the opening. This enables the patient to receive a massage while lying with his/her head on the cushion, with the result that the ear is located over the opening.

The cushion or a surface of the cushion may be made of thermoplastic material, such that lying thereon can be rendered particularly pleasant.

In order to design the device in a particularly convenient manner, the cushion is preferably realized as a housing of the device.

For reasons of appearance, on the opening here a covering may be provided which is preferably made of leather, textile, rubber or plastic or the like.

A further advantage of the covering consists in that the ear does not come into direct contact with the rotating massage part. The massage part merely serves to elevate the covering at the relevant location. It is thus possible to avoid the occurrence of sliding friction upon contact between the ear and the massage part, which can obviously involve an unpleasant sensation.

In the case of this embodiment of the invention, it may be advantageous that a height adjustment means be provided, for adjusting the relative position of the massage part and the surface of the cushion, in order to attend to differing head and ear shapes.

Particularly preferably, a preferably electric drive may be provided for the height adjustment means.

In order to enable a particularly quiet operation of the device, the motor may be realized as an electric motor.

For a simple design, a connecting element may be provided for connecting the eccentric to the shaft. It is particularly preferred here that the shaft be realized as a square or hexagonal pin, and that the connecting element can be placed on the shaft in a form-fitting manner. Clearly, the number of edges is immaterial, and a pin with any other number of edges will also fulfil the purpose.

It may be provided that the massage part, the eccentric and the connecting part, and, if appropriate, the plate, be realized as a single piece, as an attachment. By means of such attachments, the massage part can be quickly adapted to different ear shapes.

For large ears, or for a vigorous massage, the eccentric may be realized as a rod that is tilted in relation to the rotation axis.

For optimum treatment results, the rotation speed of the shaft may be at most 100 revolutions per minute, preferably at most 75 revolutions per minute, and particularly preferably at most 50 revolutions per minute.

In order that the edge of the ear can also be massaged, the eccentricity of the eccentric may be at most 7 cm, in particular 6 cm.

For massage of the inner part of the auricle, the eccentricity of the eccentric may be at most 2 cm, preferably 1 cm, and particularly preferably 5 mm to 6 mm. Similarly, the dimensions of the massage part may be between 2 cm and 4 cm, and preferably between 2.5 cm and 3.5 cm. Ideally, the dimensions of the massage part may be approximately 3 cm.

In particular in the case of use with a covering, or for use in the case of users with smaller ears, the dimensions of the massage part may also be greater than 0.5 cm, preferably approximately 0.8 cm.

In particular for embodiments with a plate, an eccentricity of at most 2 cm, preferably 5 mm to 6 mm, may be advantageous.

### BRIEF DESCRIPTION OF THE DRAWINGS

Further advantages and details of the invention are given with the help of the figures and the associated description of the figures. There are shown in

FIG. 1 a sectional representation through an ear massage device according to the invention,

FIGS. 2a to 2d various advantageous embodiments of the attachments, consisting of a connecting part, eccentric, massage part and, if appropriate, a plate,

FIG. 3 a schematic sectional representation of an ear massage device according to the invention,

FIG. 4 a schematic sectional representation of an embodiment of the invention, with a plate and massage part mounted separately on the housing,

FIG. 5 an embodiment, similar to that from FIG. 4, in which the plate sits directly on the housing,

FIG. 6 a schematic sectional representation of a device according to the invention, in which the guide profile is realized as a disc-shaped recess, and

FIGS. 7a and 7b schematic representations of a device according to the invention, wherein the shaft has a joint.

### DETAILED DESCRIPTION

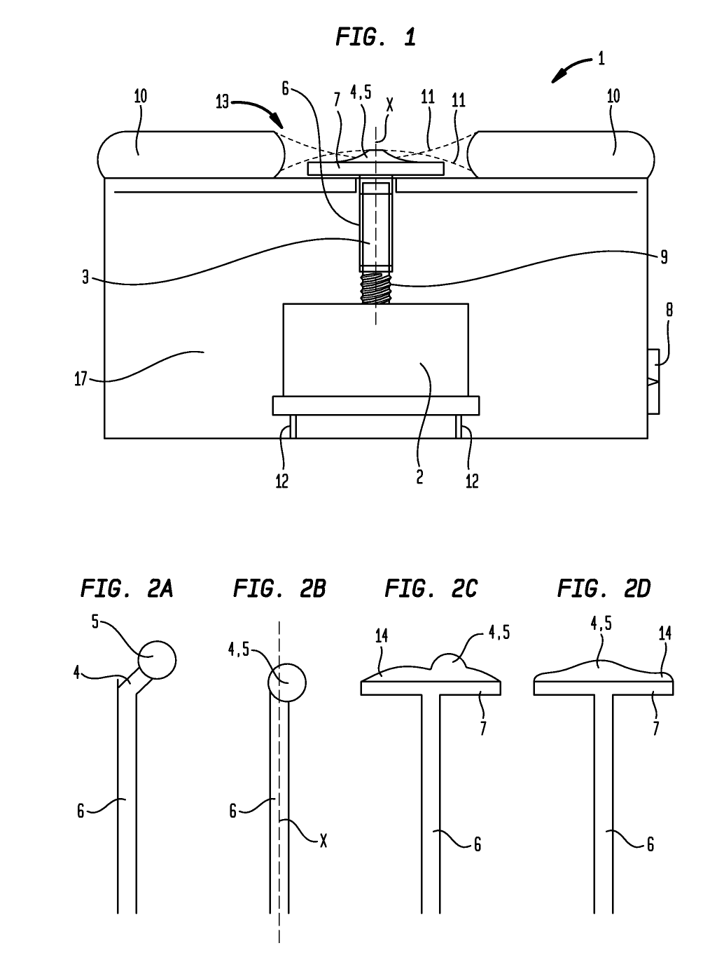

The ear massage device 1 shown in FIG. 1 has a housing 17, a motor 2, a shaft 3, a connecting part 6 and a plate 7. In this embodiment example, the eccentric 4 is designed as a single piece with the massage part 5. As can be seen, this part which is realized as a single piece is eccentric in respect of the rotation axis X of the shaft 3. In this specific embodiment example, the shaft can be rotated at 41 to 42 revolutions per minute.

The embodiment shown in FIG. 1 furthermore has a cushion 10 with an opening 13. Two possibilities for a covering 11 are drawn in using dashed lines. A spring mounting of the massage part in the direction of the rotation axis X is realized by a spring 9 between the shaft 3 and the motor 2. Clearly, this can also be achieved in a different manner, for example by spring-mounting the entire unit of the motor 2, shaft 3, eccentric 4 and massage part 5.

The height adjustment means 12 is shown only in schematic form here, since it may be realized in a great variety of ways known to a person skilled in the art.

Both the direction of rotation and the rotational speed of the motor 2 can be set on a setting device 8.

FIG. 2 shows four differing examples for combinations of connecting part 6, eccentric 4 and massage part 5, wherein those shown in FIGS. 2c and 2d have a plate 7. These plates are each provided with a padding 14. FIGS. 2a and 2c show embodiments with comparatively large eccentricities, for large ears or for a vigorous massage.

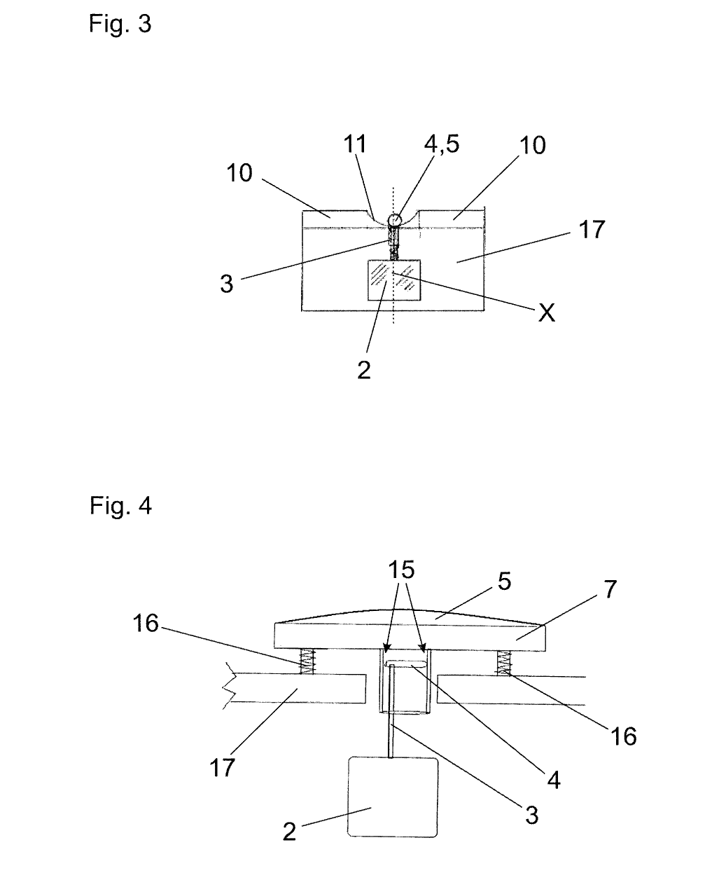

FIG. 3 shows a sectional representation of an ear massage device 1 according to the invention, wherein the attachment from FIG. 2b is used here. In this case, the covering 11 has a hole, through which the massage part 5 projects.

FIG. 4 shows an embodiment example in which the plate (7) and the massage part (5) are mounted, separately from the eccentric (4), on the housing (17). In this case, this movable mounting (16) is achieved by springs. The guide profile (15) is realized by the inner side of a tube in which the eccentric (4) is disposed.

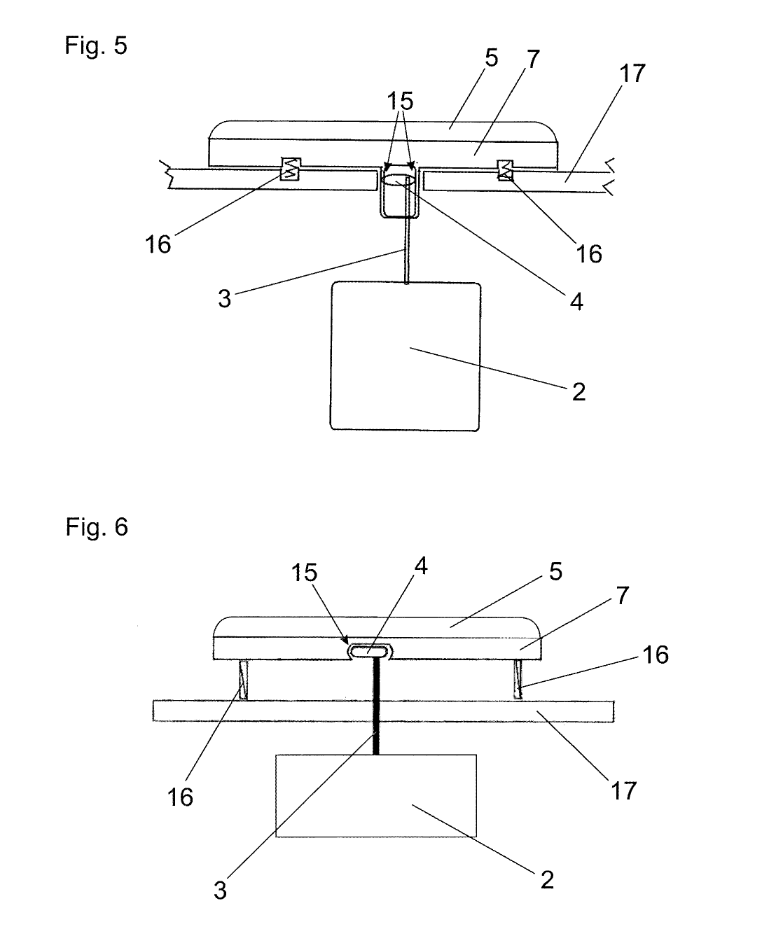

FIG. 5 shows an embodiment, similar to that from FIG. 4, wherein here the plate (7) sits directly on the housing (17). Here, the movable mounting (16) is achieved by means of recessed springs, but other solutions, for example using ball bearings, are also easily conceivable.

In FIG. 6, the guide profile (15) is realized as a disc-shaped recess. It is also possible to use, for example, annular recesses, in order to achieve somewhat greater displacements.

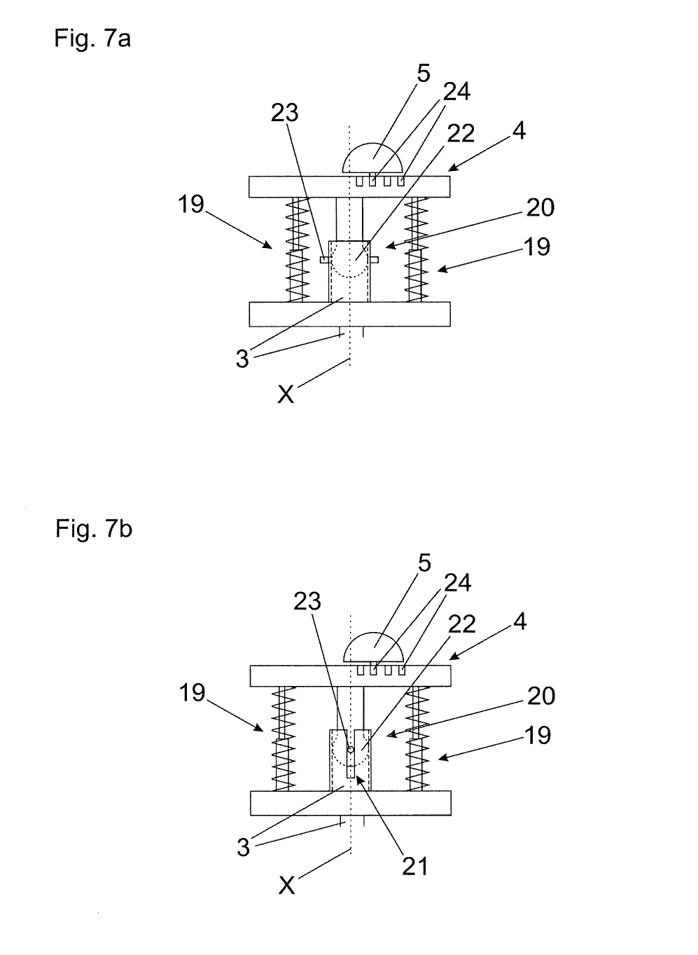

An alternative embodiment for the transmission of the rotary motion from the motor 2 to the massage part 5 is represented in FIGS. 7a and 7b. The shaft 3 has a joint 20.

Furthermore, there are three spring devices 19, which are realized as spring-damper combinations. (In FIG. 7a, one of the three spring devices 19 is concealed, such that only two spring devices 19 are visible. In FIG. 7b, one of the spring devices 19 has been masked out, in order not to interfere with the representation of the joint 20).

The representation from FIG. 7b differs from that from FIG. 7a in that the device has been rotated by 90° about the rotation axis X. The pin 23 extending through the ball 22 of the joint 20 can thus be seen from the side in FIG. 7a. The ball 22 is disposed in a tube of the shaft 3. The tube has slots 21, wherein the pins 23 act in combination with these slots 21, or engage in the latter. Since the ball 22 can be moved in the tube, along the rotation axis X, the massage part 5 can thus execute a movement, damped by the spring devices 19, along the rotation axis X. At the same time, transmission of the rotary motion of the motor 2, via the shaft 3, is ensured by the combined action of the pins 23 with the slots 21.

In addition, not only does the joint 20 tolerate movements along the rotation axis X, but the eccentric 4 can also be tilted against the rotation axis X. This results, as already mentioned, in a better response behaviour of the spring mounting.

Threaded openings 24, into which the massage part 5 can be screwed, are provided on the eccentric 4. The eccentricity of the eccentric can thereby be selected by the operator.

Moreover, it is conceivable to provide a mechanism for adjusting the eccentricity of the eccentric 4, wherein this mechanism may also be operated electrically.

The invention is not limited to the embodiment examples shown here. Thus, it is also possible to realize a device according to the invention as a hand-held appliance. Further calming functions of the device, such as, for instance, the output of music pleasant to the patient, are also conceivable.

It is furthermore conceivable to realize the device according to the invention such that it has a holding device by which it is held—including when stationary—on the head of the user, for example in a manner similar to headphones.

Furthermore, it is possible for the massage part to be mounted in a separately movable manner. This renders circular movements of the massage part possible, without the latter being rotated about the rotation axis.

Also conceivable is an arrangement for massaging an ear of a patient lying on his/her back, as well as many further embodiments.

1. Ear massage device, with a motor, a shaft that can be rotated about a rotation axis by the motor, and a massage part characterized in that an eccentric is provided, which is connected to the shaft and on which the massage part is disposed, and in that the shaft can be rotated at most at 100 revolutions per minute by the motor.

2. Device according to claim 1, wherein the motor is connected directly to the shaft.

3. Device according to claim 1, wherein the massage part is designed as a single piece with the eccentric.

4. Device according to claim 1, wherein the eccentric is detachably connected to the shaft and/or the massage part is detachably connected to the eccentric.

5. Device according to claim 1, wherein a plate, extending at right angles to the rotation axis, is connected to the massage part or is formed on the massage part.

6. Device according to claim 5, wherein a padding or a shaped part which is preferably made of plastic, rubber, foam or wood is provided on the plate.

7. Device according to claim 1, wherein the plate and/or the massage part are mounted—in particular, movably—separately from the eccentric, on a housing of the device.

8. Device according to claim 1, wherein a guide profile, which acts in combination with the eccentric, is provided on the plate or on the massage part.

9. Device according to claim 8, wherein the guide profile is realized as the inner wall of a tube.

10. Device according to claim 1, wherein the massage part is formed substantially hemispherical or spherical.

11. Device according to claim 1, wherein the shaft or the massage part is spring-mounted in the direction of the rotation axis.

12. Device according to claim 11, wherein the massage part is mounted by means of three spring devices, wherein the shaft has a joint.

13. Device according to claim 11, wherein the shaft is realized, at least partially, as a tube which has two slots that are parallel to the rotation axis, and in that the shaft has a ball and has a pin extending through the ball, transversely in relation to the rotation axis, wherein the joint is formed by combined action of the ball with the tube, on the one hand, and of the pin with the slots, on the other hand.

14. Device according to claim 1, wherein a cushion with an opening is provided, wherein the massage part is disposed in or at the opening .

15. Device according to claim 14, wherein the massage part is disposed in a relative position in relation to a surface of the cushion, characterized in that a height adjustment means is provided for adjusting the relative position.

16. Device according to claim 1, wherein a connecting element is provided for connecting the eccentric and the shaft.

17. Device according to claim 16, wherein the massage part, the eccentric and the connecting part, and preferably the plate, are realized as a single piece.
